(19) United States
(12) Patent Application Publication
(10) Pub. No.: US 2026/0111315 A1
(43) Pub. Date: Apr. 23, 2026

(54) A/B BOOT TARGET ROLLBACK MECHANISM FOR DYNAMIC SYSTEM STATE REVERSION

(71) Applicant: Red Hat, Inc., Raleigh, NC (US)

(72) Inventors: Eric Curtin, Dublin (IE); Leigh Griffin, Waterford (IE)

(21) Appl. No.: 18/922,070

(22) Filed: Oct. 21, 2024

(51) Int. Cl. G06F 11/14; G06F 9/4401

(52) U.S. Cl. CPC G06F 11/1417; G06F 9/4406; G06F 2201/805

(57) ABSTRACT

A system and method of A/B boot target rollback mechanism for dynamic system state reversion. The method includes booting a first version of an operating system (OS) into a boot target. The method includes booting a second version of the OS into the boot target to replace the first version of the OS with the second version of the OS. The method includes detecting an error associated with booting the second version of the OS into the boot target. The method includes performing, using a processing device responsive to detecting the error, a rollback procedure by booting the first version of the OS into an alternative boot target.

### TECHNICAL FIELD

The present disclosure relates generally to software technology, and more particularly, to systems and methods of A/B boot target rollback mechanism for dynamic system state reversion.

### BACKGROUND

A/B testing, or split testing, in software involves comparing two versions of a software feature or user interface to determine which one performs better. By randomly assigning users to either version A or version B, developers can collect data on user interactions and behaviors. This data is then analyzed to identify which version leads to better outcomes, such as higher user engagement, increased conversions, or improved user satisfaction. A/B testing helps in making data-driven decisions to enhance the user experience and optimize software performance.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment A/B boot target rollback mechanism for dynamic system state reversion, according to some embodiments;

FIG. 2A is a block diagram depicting an example of the DBS system 104 in FIG. 1, according to some embodiments;

FIG. 2B is a block diagram depicting an example of the administrator device 118 of the environment in FIG. 1, according to some embodiments;

FIG. 2C is a block diagram depicting an example environment of a system to perform a dynamic boot target selection, according to some embodiments;

FIG. 3 is a flow diagram depicting a method of incorporating a dynamic boot target selection into the rollback process to improve performance and reliability of a computing device, according to some embodiments;

FIG. 4 is a block diagram of an example computing device that may perform one or more of the operations described herein, in accordance with some embodiments.

### DETAILED DESCRIPTION

The traditional approach to system, e.g., operating system (OS), updates often involves A/B updates (e.g., split testing), where one storage area (e.g., partition or directory) is updated while the other remains unchanged, allowing for seamless rollback in case of errors.

However, this method is limited in its flexibility, particularly when it comes to managing the operating system's boot target. For example, when a rollback is necessary due to a failed update or compatibility issues, reverting to the previous state might not fully address the problem. This is especially true when the issue lies within the boot process or the initialization of system services. Conventional A/B rollback mechanisms do not provide a solution tailored to address the issues related to an OS-level rollback, such as a problematic firmware update or a hardware failure.

Furthermore, the identified problem is exacerbated by the rigid structure of existing update and rollback procedures, which often lack the capability to adjust the boot target dynamically. As a result, system administrators and users may face prolonged downtime or operational disruptions while attempting to resolve boot-related failures. This allows outdated code to continue to run in a computing environment (e.g., private network, corporate network, and/or the like), where the outdated code is free to introduce a plethora of security vulnerabilities that degrade the computing environment. Furthermore, the outdated code could allow a malicious attacker to gain access to the computing network and exploit and/or waste the computing resources (e.g., memory, storage, processing, and/or networking) of the computing environment. Thus, there is a long-felt but unsolved need to solve the problems related to managing the A/B boot target rollback for a computing network.

Aspect of the present disclosure address the above-noted and other deficiencies by describing a dynamic boot target selection (DBS) system that incorporates a dynamic boot target selection procedure into the rollback process to address this critical gap in system management. This DBS system allows for more effective recovery from update failures by enabling the system to roll back into an alternative system boot target (e.g., systemd boot target in Linux), thereby bypassing boot-related issues encountered ln the default configuration. Advantageously, this innovation enhances system reliability and minimizes downtime, ultimately improving the overall user experience, operational efficiency, and operational security.

As discussed in greater detail below, the present disclosure describes a DBS system that performs an enhanced system rollback procedure that seamlessly transitions the computing system into an alternative boot target (e.g., alternative system boot target) upon rollback initiation of the operating system (e.g., from version 2 to version 1). The alternative boot target is preconfigured to provide a stable and functional environment, thereby circumventing any boot-related issues encountered in the default configuration. In other words, the DBS system prevents the boot-related issues that commonly occur when executing the default configuration by deciding to execute the alternative boot target instead of the default configuration. The enhanced system rollback procedure includes one or more of the following operations:

Rollback Trigger: The DBS system initiates the rollback process in response to detecting an update failure. The DBS system uses a simple rules engine to detect the update failure. This trigger prompts the DBS system to revert to the previous state. In some embodiments, the DBS system can be manually triggered to perform this reversion.

Alternative Boot Target Selection: Upon rollback initiation, the DBS dynamically selects an alternative system boot target designed to mitigate the specific boot-related issue(s) encountered during the failed update. This alternative boot target is configurable and is represented in the rules engine in a prioritized order, meaning a combinatorial approach to a plurality of errors that caused the trigger may demand a different alternative boot strategy as compared to a singular error detected.

Recovery: Following the rollback, the DBS system may automatically perform some recovery tasks through restoring system / service states to a prior known working position (e.g., if feasible and if snapshots existed).

Operational Resumption: Once recovery is successfully completed, the DBS system resumes normal operation to provide users with access to a stable and fully functional environment. That is, users can continue their tasks without experiencing the adverse effects of the failed update.

Thus, the embodiments of the present disclosure revolutionize system rollback procedures by introducing a dynamic boot target selection mechanism that effectively addresses boot-related issues encountered during updates. By using an enhanced system rollback procedure to seamlessly transition a computing system into an alternative boot target, the computing system is able to optimize system reliability, minimize downtime, and improve the overall user experience.

In an illustrative embodiment, a DBS system boots a first version of an operating system (OS) into a boot target. The DBS system boots a second version of the OS into the boot target to replace the first version of the OS with the second version of the OS. The DBS system detects an error associated with booting the second version of the OS into the boot target. The DBS system performs, using a processing device responsive to detecting the error, a rollback procedure by booting the first version of the OS into an alternative boot target.

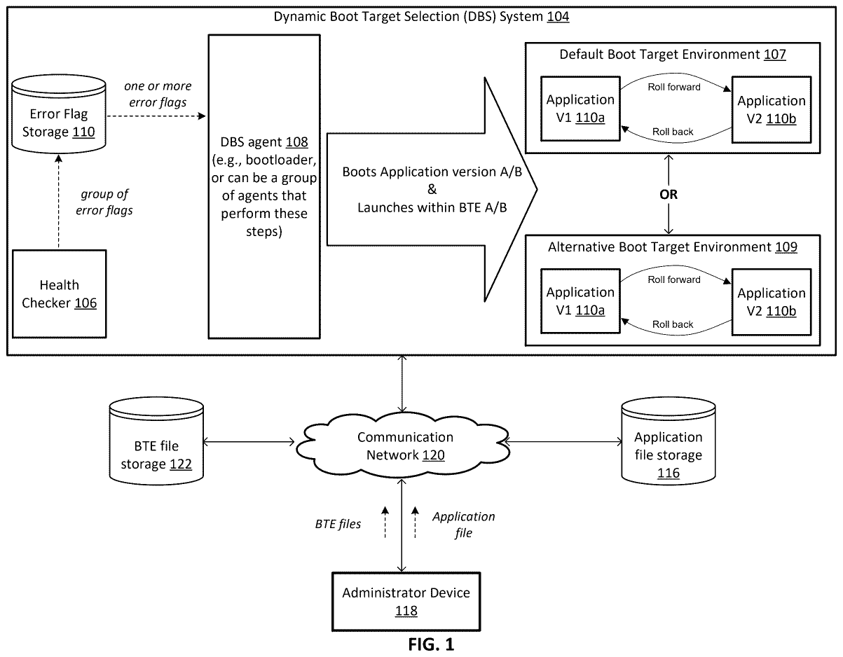

FIG. 1 is a block diagram depicting an example environment A/B boot target rollback mechanism for dynamic system state reversion, according to some embodiments. The environment 100 includes a dynamic boot target selection (DBS) system 104, an administrator device, an application file storage 116, and a boot target environment (BTE) file storage 122 that are each coupled together through a communication network 120.

The DBS system 104 is configured to executes a single boot target environment at a time. For example, the DBS system 104 can execute either a default boot target environment 107 or an alternative boot target environment 109. A running (e.g., executing, active) boot target environment can execute a particular version of an application 110 (e.g., application 110a, application 110b) within itself. For example, a running boot target environment can execute version 1 (V1) of application 110a or version (V2) of the application 110b. Application 110a and 110b may be different from one another with respect to features, stability, security vulnerabilities, etc.

An application 110 may be any type of software operating system including, for example, Microsoft Windows®, macOS®, Linux®, Android®, VxWorks®, Quantux UNIX (QNX). In other embodiments, an application 110 may be any type of software application that provides any type of service (e.g., a network service, a computing service, a security service, etc.) for the DBS system 104. For example, the application 110 may be an antivirus application that protects the computing resources of the DBS system 104 from malicious activity, such as phishing attacks, viruses, malware, and ransomware. As another example, the application 110 may be a navigation application that provides navigation services (e.g., Global Positioning System (GPS) coordinates) for a vehicle.

Different versions of the same application 110 provide different types of services. For example, a first version (e.g., V1) of an application (e.g., application 110a) may provide a low-bandwidth networking service for the DBS system 104, but after upgrading the application to a second version (e.g., V2), the application (e.g., application 110b) may provide a high-bandwidth networking service for the DBS system 104. In some embodiments, the application 110 may be a functional safety application that provides a critical service for the DBS system 104, a user of the DBS system 104, and/or other computing devices. A critical service may be a service that impacts a safety of a user that is associated with the DBS system 104. For example, the application 110 may be configured to provide a service (e.g., Fusa) to a vehicle to control the movement (e.g., acceleration, velocity, breaking, and/or steering) of the vehicle.

The DBS system 104 includes a health checker 106 that monitors a running boot target environment and any of the applications that are running within the boot target environment for errors. If the health checker 106 detects an error, then the health checker 106 generates one or more error flags to indicate that there were errors associated with the running boot target environment and/or the applications that are running within the boot target environment. The error flag may include any information that an administrator may find useful to debug the error. For example, the error flag may include an application name, application version, boot target environment name, boot target environment version, and/or information describing the symptoms of the error.

The DBS system 104 includes and/or executes a DBS agent 108 that reads one or more error flags from the error flag storage 110 and decides, based on the error flags, which boot target environment (e.g., default boot target environment 107 or alternative boot target environment 109) to boot and which version of an application (e.g., application 110a or application 110b) to launch within the boot target environment.

A boot target environment refers to a specific state or mode that an operating system boots into. In Linux, for example, the boot target environment is referred to as systemd. Boot targets are essentially groups of services that define what the system should be doing at a given time.

The default boot target environment 107 may be any type of boot target environment including, for example, a graphical. target that boots the system into a graphical user interface (GUI) similar to the traditional runlevel 5; a multi-user. target that boots the system into a multi-user, non-graphical mode that is similar to the traditional runlevel 3 used for servers; a rescue. target that boots the system into a single-user mode with basic services that are useful for system recovery and maintenance; or an emergency.target that boots the system into a minimal environment with only the most essential services running, which is useful for troubleshooting severe issues.

However, the alternative boot target environment 109 is a modified version of the default boot target environment, but able to run without experiencing the errors that occur when running the default boot target environment 107. For example, the DBS system 104 or an administrator using the administrator device may generate (e.g., configure) the alternative boot target environment 109 by modifying portions of a copy of the default boot target environment 107 to resolve (or bypass) any boot-related issues associated with the default boot target environment 107.

Thus, the health checker 106 and the DBS agent 108 work together to mitigate or prevent errors that occur during the execution of a boot target environment and/or apps within the boot target environment. Specifically, the health checker 106 stores the error flags in the error flag storage 110 for the purpose of triggering (e.g., notifying, informing) the DBS agent 108 to roll-back an application (which is currently booted into the default boot target) to a previous version of the application, or trigger the DBS agent 108 to roll-back the application to a previous version by booting the previous version of the application into an alternative boot target.

The DBS system 104 and administrator device 118 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

The administrator device 118 stores BTE files (e.g., executable BTE files) in the BTE file storage 122 and application files (e.g., executable application files, .exe, .bat, .msi, .apk, .bin, etc.) in the application file storage 116. The administrator device 118 can also provide any of these files to the DBS system 104.

Still referring to FIG. 1, the DBS agent 108 boots a first version (e.g., application 110a) of an operating system (OS) into the boot target environment (e.g., default boot target environment). The DBS agent 108 boots a second version (e.g., application 110b) of the OS into the boot target environment to replace the first version of the OS with the second version of the OS. The DBS agent 108 detects an error associated with booting the second version of the OS into the boot target environment. The DBS agent 108 performs, responsive to detecting the error, a rollback procedure by booting the first version of the OS into an alternative boot target (e.g., alternative boot target environment 109).

Although FIG. 1 shows only a select number of computing devices (e.g., DBS system 104, administrator device 118, etc.), components (e.g., DBS agent 108,, error flag storage 110, health checker 106, etc.), and storage and/or databases (e.g., BTS file storage 1120, application file storage 116, etc.), the environment 100 may include any number of computing devices, components, and databases that are interconnected in any arrangement to facilitate the exchange of data between the computing devices.

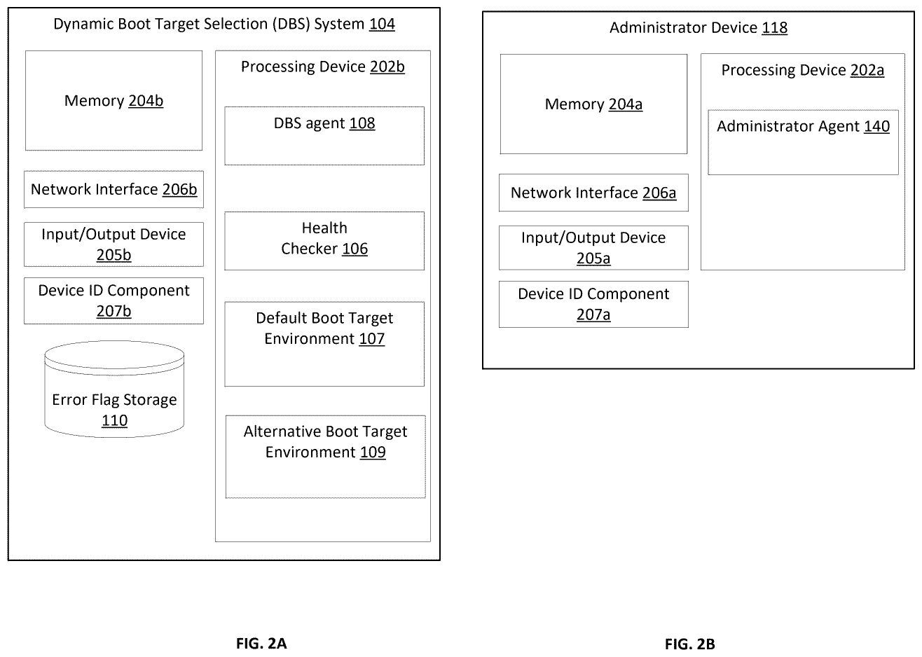

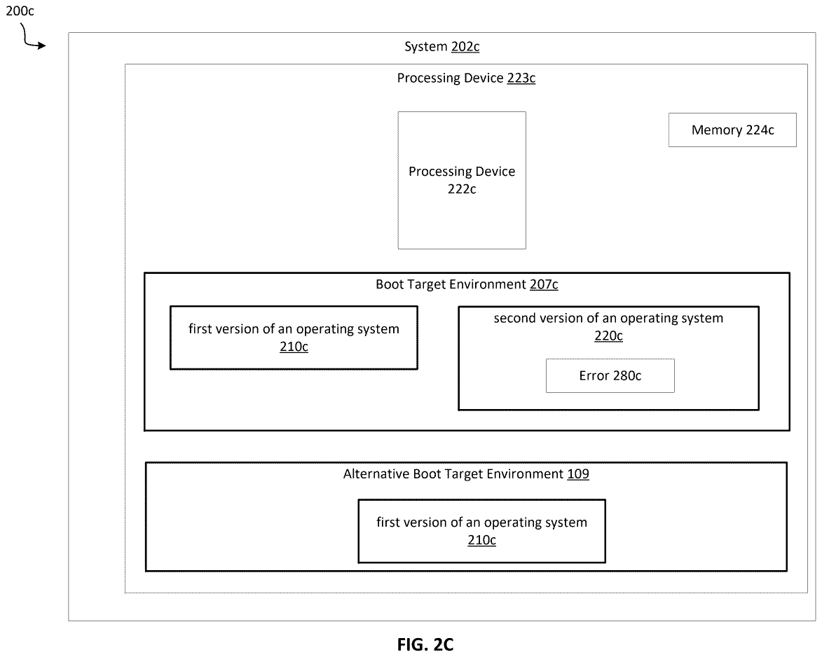

FIG. 2A is a block diagram depicting an example of the DBS system 104 in FIG. 1, according to some embodiments. While various devices, interfaces, and logic with particular functionality are shown, it should be understood that the DBS system 104 may include any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The DBS system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the DBS system 104. In some embodiments, the processing device 202a and the memory 204a form various processing devices and/or circuits described with respect to the DBS system 104. The instructions include code from any suitable computer programming language such as, but not limited to, C, C++, C #, Java, JavaScript, VBScript, Perl, HTML, XML, Python, TCL, and Basic.

The processing device 202a executes a DBS agent 108, health checker 106, a default boot target environment 107, and an alternative boot target environment 109. The DBS agent 108 boots a first version of an OS into a boot target (e.g., boot target environment). The DBS agent 108 boots a second version of the OS into the boot target to replace the first version of the OS with the second version of the OS. The DBS agent 108 detect an error associated with booting the second version of the OS into the boot target. The DBS agent 108 performs, using a processing device responsive to detecting the error, a rollback procedure by booting the first version of the OS into an alternative boot target.

The DBS agent 108 generates the first version of the OS based on a dataset. The DBS agent 108 modifies the dataset to generate a modified dataset. The DBS agent 108 generates the second version of the OS based on the modified dataset.

The DBS agent 108 detects the error associated with booting the second version of the OS into the boot target by determining that the second version of the OS prematurely stopped booting at a particular point during the booting of the second version of the OS; and comparing the particular point to a predefined point associated with the booting of the second version of the OS.

The DBS agent 108 detects the error associated with booting the second version of the OS into the boot target by determining that the second version of the OS booted into the boot target; and determining that the error occurs after the second version of the OS booted into the boot target.

The DBS agent 108 detects the error associated with booting the second version of the OS into the boot target by reading an error flag from a data storage location; and determining that the error flag indicates one or more errors associated with booting the second version of the OS into the boot target.

The DBS agent 108 detects the error associated with booting the second version of the OS into the boot target by re-booting the second version of the OS into the boot target; and detecting a second error associated with re-booting the second version of the OS into the boot target.

The DBS agent 108 performs the rollback procedure by terminating the second version of the OS to prevent the second version from executing in the boot target.

The DBS agent 108 determines a severity level associated with the error; determine whether the severity level satisfies a predefined threshold value; and either: perform a remedy procedure to mitigate the error responsive to determining that the severity level satisfies the predefined threshold value, or perform a roll-forward procedure by booting the second version of the OS into the boot target responsive to determining that the severity level does not satisfy the predefined threshold value.

In some embodiments, the alternative boot target is configured to disable one or more software services that are permitted to execute in the boot target, enable one or more software services that are prohibited to execute in the boot target, or disable one or more hardware components that are permitted to execute in the boot target.

The DBS agent 108 selects, from a plurality of services, a particular service based on the error; and configures the alternative boot target to launch the particular service responsive to performing the rollback procedure.

The DBS system 104 includes a network interface 206a configured to establish a communication session with a computing device for sending and receiving data over a communication network to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the DBS system 104 includes a plurality of network interfaces 206a of different types, allowing for connections to a variety of networks, such as local area networks (public or private) or wide area networks including the Internet, via different sub-networks.

The DBS system 104 includes an input/output device 205a configured to receive user input from and provide information to a user. In this regard, the input/output device 205a is structured to exchange data, communications, instructions, etc. with an input/output component of the DBS system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the DBS system 104, such as a built-in display, touch screen, microphone, etc., or external to the housing of the DBS system 104, such as a monitor connected to the DBS system 104, a speaker connected to the DBS system 104, etc., according to various embodiments. In some embodiments, the DBS system 104 includes communication circuitry for facilitating the exchange of data, values, messages, and the like between the input/output device 205a and the components of the DBS system 104. In some embodiments, the input/output device 205a includes machine-readable media for facilitating the exchange of information between the input/output device 205a and the components of the DBS system 104. In still another embodiment, the input/output device 205a includes any combination of hardware components (e.g., a touchscreen), communication circuitry, and machine-readable media.

The DBS system 104 includes a device identification component 207a (shown in FIG. 2A as device ID component 207a) configured to generate and/or manage a device identifier (sometimes referred to as, “node ID”) associated with the DBS system 104. The device identifier may include any type and form of identification used to distinguish the DBS system 104 from other computing devices. In some embodiments, to preserve privacy, the device identifier may be cryptographically generated, encrypted, or otherwise obfuscated by any device and/or component of DBS system 104. In some embodiments, the DBS system 104 may include the device identifier in any communication (e.g., public encrypted message, private encrypted message, etc.) that the DBS system 104 sends to a computing device.

The DBS system 104 includes a bus (not shown), such as an address/data bus or other communication mechanism for communicating information, which interconnects the devices and/or components of DBS system 104, such as processing device 202a, network interface 206a, input/output device 205a, and/or device ID component 207a.

In some embodiments, some or all the devices and/or components of DBS system 104 may be implemented with the processing device 202a. For example, the DBS system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of the administrator device 118 of the environment in FIG. 1, according to some embodiments. While various devices, interfaces, and logic with particular functionality are shown, it should be understood that the administrator device 118 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The administrator device 118 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2a, but with respect to devices and/or components of the administrator device 118 instead of devices and/or components of the DBS system 104.

The memory 204b of processing device 202b stores data and/or computer instructions/code for facilitating at least some of the various processes described herein. The memory 204b includes identical or nearly identical functionality as memory 204a in FIG. 2A, but with respect to devices and/or components of the administrator device 118 instead of devices and/or components of the DBS system 104.

The processing device 202a of the administrator device 118 may execute an administrator agent 140 that stores BTE files (e.g., executable BTE files) in the BTE file storage 122. The administrator agent 140 stores application files (e.g., executable application files, .exe, .bat, .msi, .apk, .bin, etc.) in the application file storage 116. The administrator agent 140 can also provide any of these files to the DBS system 104.

The administrator device 118 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the administrator device 118 instead of devices and/or components of the DBS system 104.

The administrator device 118 includes an input/output device 205b configured to receive user input from and provide information to a user. In this regard, the input/output device 205b is structured to exchange data, communications, instructions, etc. with an input/output component of the administrator device 118. The input/output device 205b includes identical or nearly identical functionality as input/output device 205a in FIG. 2A, but with respect to devices and/or components of the administrator device 118 instead of devices and/or components of the DBS system 104.

The administrator device 118 includes a device identification component 207b (shown in FIG. 2B as device ID component 207b) configured to generate and/or manage a device identifier associated with the DBS system 104. The device ID component 207b includes identical or nearly identical functionality as device ID component 207a in FIG. 2A, but with respect to devices and/or components of the administrator device 118 instead of devices and/or components of the DBS system 104.

The administrator device 118 includes a bus (not shown), such as an address/data bus or other communication mechanism for communicating information, which interconnects the devices and/or components of the administrator device 118, such as processing device 202b, network interface 206b, input/output device 205b, and/or device ID component 207b.

In some embodiments, some or all the devices and/or components of administrator device 118 may be implemented with the processing device 202b. For example, the administrator device 118 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment of a system to perform a dynamic boot target selection, according to some embodiments. A system 202c (e.g., DBS system 104 in FIG. 2A) includes a processing device 222c and memory 224c coupled to the processing device 222c. The processing device 222 boots a first version of an operating system 210c into a boot target environment 207c. The processing device 222c boots a second version of the OS 220c into the boot target environment 207c to replace the first version of the OS 210c with the second version of the OS 220c. The processing device 223c detects an error 280c associated with booting the second version of the OS 220c into the boot target environment 207c. The processing device 223c performs, responsive to detecting the error 280c, a rollback procedure by booting the first version of the OS 210c into an alternative boot target 230c.

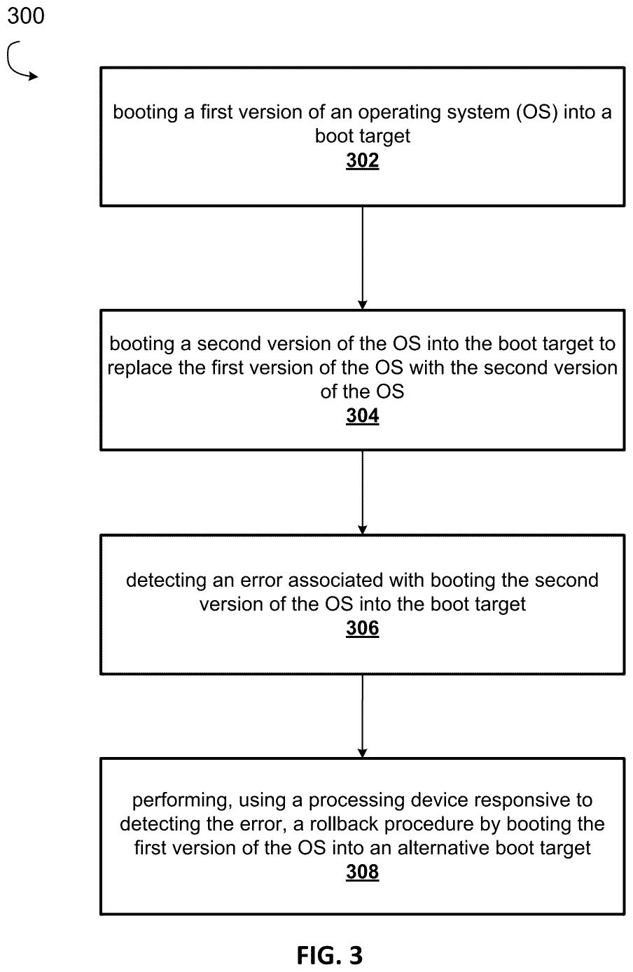

FIG. 3 is a flow diagram depicting a method of incorporating a dynamic boot target selection into the rollback process to improve performance and reliability of a computing device, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 300 may be performed by a DBS system, such as DBS system 104 in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of booting a first version of an operating system (OS) into a boot target. The method 300 includes the block 304 of booting a second version of the OS into the boot target to replace the first version of the OS with the second version of the OS. The method 300 includes the block 306 of detecting an error associated with booting the second version of the OS into the boot target. The method of 300 includes the block 308 of performing, using a processing device responsive to detecting the error, a rollback procedure by booting the first version of the OS into an alternative boot target instead of the boot target.

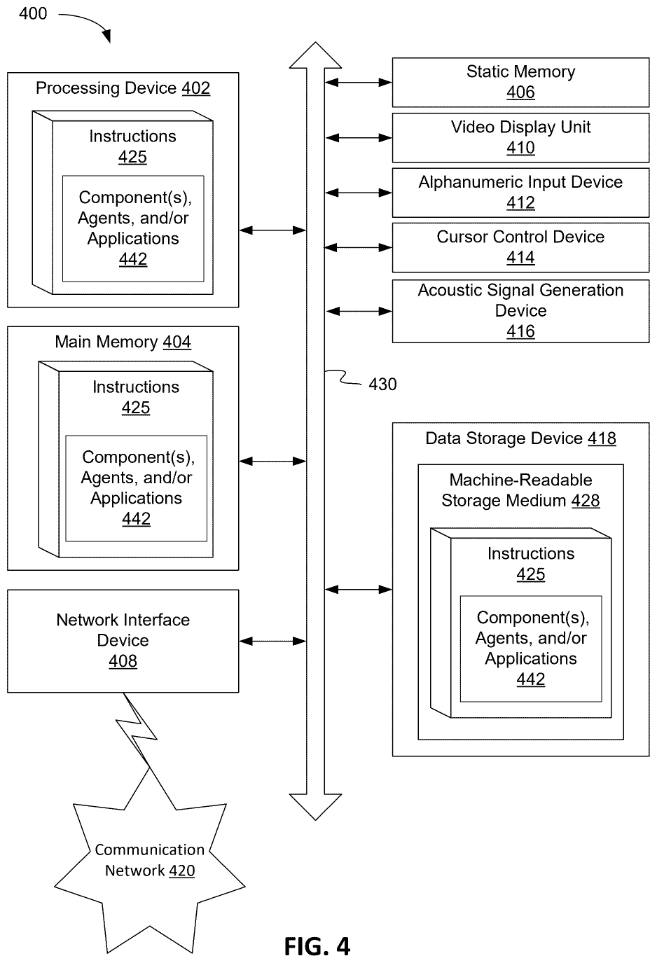

FIG. 4 is a block diagram of an example computing device 400 that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components, agents, and/or applications 442 (e.g., DBS agent 108, application 110, health checker 106 in FIG. 1) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “acquiring,” “determining,” “denying” “allowing,” “installing,” “processing,” “validating,” “authenticating,” “identifying,” “instructing” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
booting a first version of an operating system (OS) into a boot target;
booting a second version of the OS into the boot target to replace the first version of the OS with the second version of the OS;
detecting an error associated with booting the second version of the OS into the boot target; and
performing, using a processing device responsive to detecting the error, a rollback procedure by booting the first version of the OS into an alternative boot target.

2. The method of claim 1, further comprising:
generating the first version of the OS based on a dataset;
modifying the dataset to generate a modified dataset; and
generating the second version of the OS based on the modified dataset.

3. The method of claim 1, wherein detecting the error associated with booting the second version of the OS into the boot target comprises:
determining that the second version of the OS prematurely stopped booting at a particular point during the booting of the second version of the OS; and
comparing the particular point to a predefined point associated with the booting of the second version of the OS.

4. The method of claim 1, wherein detecting the error associated with booting the second version of the OS into the boot target comprises:
determining that the second version of the OS booted into the boot target; and
determining that the error occurs after the second version of the OS booted into the boot target.

5. The method of claim 1, wherein detecting the error associated with booting the second version of the OS into the boot target comprises:
reading an error flag from a data storage location; and
determining that the error flag indicates one or more errors associated with booting the second version of the OS into the boot target.

6. The method of claim 1, wherein detecting the error associated with booting the second version of the OS into the boot target comprises:
re-booting the second version of the OS into the boot target; and
detecting a second error associated with re-booting the second version of the OS into the boot target.

7. The method of claim 1, wherein performing the rollback procedure further comprises:
terminating the second version of the OS to prevent the second version from executing in the boot target.

8. The method of claim 1, further comprising:
determining a severity level associated with the error; and
determining whether the severity level satisfies a predefined threshold value; and either:
performing a remedy procedure to mitigate the error responsive to determining that the severity level satisfies the predefined threshold value, or
performing a roll-forward procedure by booting the second version of the OS into the boot target responsive to determining that the severity level does not satisfy the predefined threshold value.

9. The method of claim 1, wherein the alternative boot target is further to:
disable one or more software services that are permitted to execute in the boot target,
enable one or more software services that are prohibited to execute in the boot target, or
disable one or more hardware components that are permitted to execute in the boot target.

10. The method of claim 1, further comprising:
selecting, from a plurality of services, a particular service based on the error; and
configuring the alternative boot target to launch the particular service responsive to performing the rollback procedure.

11. A system comprising:
a memory; and
a processing device, operatively coupled to the memory, to:
boot a first version of an operating system (OS) into a boot target;
boot a second version of the OS into the boot target to replace the first version of the OS with the second version of the OS;
detect an error associated with booting the second version of the OS into the boot target; and
perform, responsive to detecting the error, a rollback procedure by booting the first version of the OS into an alternative boot target.

12. The system of claim 11, wherein the processing device is to:
generate the first version of the OS based on a dataset;
modify the dataset to generate a modified dataset; and
generate the second version of the OS based on the modified dataset.

13. The system of claim 11, wherein to detect the error associated with booting the second version of the OS into the boot target, the processing device is to:
determine that the second version of the OS prematurely stopped booting at a particular point during the booting of the second version of the OS; and
compare the particular point to a predefined point associated with the booting of the second version of the OS.

14. The system of claim 11, wherein to detect the error associated with booting the second version of the OS into the boot target, the processing device is to:
determine that the second version of the OS booted into the boot target; and
determine that the error occurs after the second version of the OS booted into the boot target.

15. The system of claim 11, wherein to detect the error associated with booting the second version of the OS into the boot target, the processing device is to:
read an error flag from a data storage location; and
determine that the error flag indicates one or more errors associated with booting the second version of the OS into the boot target.

16. The system of claim 11, wherein to detect the error associated with booting the second version of the OS into the boot target, the processing device is to:
re-boot the second version of the OS into the boot target; and
detect a second error associated with re-booting the second version of the OS into the boot target.

17. The system of claim 11, wherein to perform the rollback procedure, the processing device is further to:
terminate the second version of the OS to prevent the second version from executing in the boot target.

18. The system of claim 11, wherein the processing device is to:
determine a severity level associated with the error;
determine whether the severity level satisfies a predefined threshold value; and either:
perform a remedy procedure to mitigate the error responsive to determining that the severity level satisfies the predefined threshold value, or
perform a roll-forward procedure by booting the second version of the OS into the boot target responsive to determining that the severity level does not satisfy the predefined threshold value.

19. The system of claim 11, wherein the alternative boot target is configured to:
disable one or more software services that are permitted to execute in the boot target, enable one or more software services that are prohibited to execute in the boot target, or disable one or more hardware components that are permitted to execute in the boot target.

20. The system of claim 11, wherein the processing device is to:
select, from a plurality of services, a particular service based on the error; and
configure the alternative boot target to launch the particular service responsive to performing the rollback procedure.

21. A non-transitory computer-readable medium storing instructions that, when execute by a processing device, cause the processing device to:
boot a first version of an operating system (OS) into a boot target;
boot a second version of the OS into the boot target to replace the first version of the OS with the second version of the OS;
detect an error associated with booting the second version of the OS into the boot target; and
perform, using a processing device responsive to detecting the error, a rollback procedure by booting the first version of the OS into an alternative boot target.
